(19) United States
(12) Patent Application Publication
(10) Pub. No.: US 2006/0073422 A1
(43) Pub. Date: Apr. 6, 2006

(54) Portable conformable deep ultraviolet master mask

(75) Inventors: Jathan D. Edwards, Afton, MN (US); Terry L. Morkved, White Bear Lake, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/953,198

(22) Filed: Sep. 28, 2004

(51) Int. Cl. G03C 5/00

(52) U.S. Cl. 430/320; 430/321

(57) ABSTRACT

Mastering techniques are described that can improve the quality of a master used in data storage disk manufacturing. In particular, the techniques can improve resolution of the features created on the master. The techniques include coating a master substrate layer with a tri-layer structure composed of a top photoresist layer, a bottom photoresist layer, and a non-resist layer interposed between the two photoresist layers. The bottom photoresist layer comprises a deep ultraviolet (DUV) resist material. Mastering the top photoresist layer defines a portable conformable mask (PCM) for the bottom photoresist layer. A variety of PCM may be defined for the bottom photoresist layer. The PCM may be defined using conventional tip recording with a focused laser spot that provides fine feature definition. A blanket DUV light may then illuminate the bottom photoresist layer through the PCM to provide enhanced feature resolution in a data storage disk master.

### TECHNICAL FIELD

The invention relates to manufacturing techniques for creation of optical data storage disks.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase change optical disks, and others. Some newer formats for optical data storage disks are progressing toward smaller disk sizes and increased data storage density. Many new formats boast improved track pitches and increased storage density using blue-wavelength lasers for data readout and/or data recording. A wide variety of optical data storage disk standards have been developed and other standards will continue to emerge.

Optical data storage disks are typically produced by first making a data storage disk master that has a surface pattern that represents encoded data on the master surface. The surface pattern, for instance, may be a collection of grooves or other features that define master pits and master lands, e.g., typically arranged in either a spiral or concentric manner. The master is typically not suitable as a mass replication surface with the master features defined within an etched photoresist layer formed over a master substrate.

After creating a suitable master, that master can be used to make a stamper, which is less fragile than the master. The stamper is typically formed of electroplated metal or a hard plastic material, and has a surface pattern that is the inverse of the surface pattern encoded on the master. An injection mold can use the stamper to fabricate large quantities of replica disks. Also, photopolymer replication processes have used stampers to fabricate replica disks. In any case, each replica disk may contain the data and tracking information that was originally encoded on the master surface. The replica disks can be coated with a reflective layer and/or a phase change layer, and are often sealed with an additional protective layer. Other media formats, such as magnetic disk formats, may also use similar mastering-stamping techniques, e.g., to create media having small surface features which correspond to magnetic domains.

In some cases, the surface pattern encoded on the data storage disk master represents an inverse of the desired replica disk pattern. In those cases, the master is typically used to create a first-generation stamper, which is in turn used to create a second-generation stamper. The second-generation stamper, then, can be used to create replica disks that contain an inverse of the surface pattern encoded on the master. Creating multiple generations of stampers can also allow for improved replica disk productivity from a single data storage disk master.

The mastering process is one of the most critical stages of the data storage disk manufacturing process. In particular, the mastering process defines the surface pattern to be created in replica disks. The master will pass on any variations or irregularities to stampers and replica disks, and therefore, the creation of a high quality master is important to the creation of high quality replica disks. Furthermore, the resolution and precision limitations of the master disk are translated to resolution and precision limitations on the resulting replica disks. For this reason, it is highly desirable to improve mastering techniques which impact master disk quality, resolution and precision.

The mastering process commonly uses a photolithographic process to define the master surface pattern. To facilitate the mastering process, an optically flat master substrate is coated with a layer of photoresist. A tightly focused laser beam passes over the photoresist-coated substrate to expose grooves or other latent features in the photoresist, which may be categorized as a direct-write photolithographic technique. The focused beam may also be modulated or wobbled to define information such as encoded data, tracking servos, or the like, within the features of the master disk. After exposing the photoresist, a developer solution removes either the exposed or unexposed photoresist, depending on whether a positive or negative photoresist material is used. In this development step, the latent exposure pattern is manifest as a topographical master pattern.

### SUMMARY

In general, the invention is directed to mastering techniques that can improve the quality of a master used in data storage disk manufacturing. In particular, the techniques described herein can improve resolution of the features created on the master. The techniques include coating a master substrate layer with a trilayer structure composed of a top photoresist layer, a bottom photoresist layer, and a non-resist layer interposed between the two photoresist layers. The bottom photoresist layer comprises a deep ultraviolet (DV) resist material. Mastering the top photoresist layer defines a contact mask, or portable conformable mask (PCM), for the bottom photoresist layer.

The PCM may be defined using conventional tip recording with a focused laser spot that provides fine feature definition. A blanket DUV light may then illuminate the bottom photoresist layer through the high resolution contact mask. The two photoresist layers may comprise differing optical properties such that the bottom photoresist layer can be mastered through the contact mask defined by the top photoresist layer without photolithographically processing the top photoresist layer.

A variety of contact masks may be defined for the bottom photoresist layer. In one case, the contact mask is defined with an optical contrast between a photolithographically defined region of the top photoresist layer and an undeveloped region of the top photoresist layer. In another case, the contact mask is defined with the top photoresist layer by photolithographically exposing and developing the top photoresist layer. In a further case, the contact mask is defined with a combination of the top photoresist layer and the non-resist layer by photolithographically exposing and developing the top photoresist layer and etching the non-resist layer.

The DUV light used to master the bottom photoresist layer comprises a wavelength less than 300 nanometers. The top photoresist layer may comprise a UV resist material, such as a mid-UV resist material, or a violet resist material. In the case of the UV resist material, the focused laser spot comprises a UV laser spot with a wavelength between 400 nanometers and 300 nanometers. In the case of the violet resist material, the focused laser spot comprises a violet laser spot with a wavelength between 460 nanometers and 400 nanometers. In either case, the top photoresist material is substantially opaque to the DUV light, e.g., having a wavelength less than 300 nanometers. Depending on the type of contact mask defined for the bottom photoresist layer, the non-resist layer may comprise a material substantially transparent to the DUV light.

In one embodiment, the invention is directed to a method of creating a data storage disk master. The method comprises coating a substrate layer of the master with a top photoresist layer, a bottom photoresist layer, and a non-resist layer interposed between the top and bottom photoresist layers, wherein the bottom photoresist layer comprises a deep ultraviolet (DUV) resist material. The method further comprises defining a contact mask for the bottom photoresist layer by mastering the top photoresist layer, and illuminating the bottom photoresist layer through the contact mask with a DUV light to photolithographically define a feature of the master in the bottom photoresist layer.

In another embodiment, the invention is directed to a data storage disk master comprising a substrate layer, a bottom photoresist layer, a non-resist layer, and a top photoresist layer. The bottom photoresist layer comprises a deep ultraviolet (DUV) resist material coated on the substrate layer. The non-resist layer is deposited adjacent the bottom photoresist layer and the top photoresist layer is coated on the non-resist layer. The top photoresist layer is mastered to create a contact mask for the bottom photoresist layer and the bottom photoresist layer is illuminated through the contact mask with a DUV light to photolithographically define a feature of the master in the bottom photoresist layer.

In another embodiment, the invention is directed to a method of creating a data storage disk master. The method comprises coating a substrate layer of the master with a top photoresist layer, a bottom photoresist layer, and a non-resist layer interposed between the top and bottom photoresist layers, wherein the bottom photoresist layer comprises a deep ultraviolet (DUV) resist material. The method further comprises illuminating the top photoresist layer with a focused laser spot to photolithographically define a feature of the master in the top photoresist layer. The top photoresist layer is developed to physically expose a region of the non-resist layer, and the physically exposed region of the non-resist layer is then etched to physically define the feature of the master in the non-resist layer. The method also includes illuminating the bottom photoresist layer through the physically defined region of the non-resist layer with a DUV light to photolithographically define the feature of the master in the bottom photoresist layer. Finally, the bottom photoresist layer is developed to physically define the feature of the master in the bottom photoresist layer.

The invention may be capable of providing one or more advantages. The described techniques can improve resolution of the features created on the data storage disk master by increasing resolution of the portable conformable mask (PCM) for the bottom photoresist layer. For example, developing the top photoresist layer creates a top photoresist sidewall with a first sidewall angle relative to a horizontal plane. The non-resist layer may then be etched through the developed region of the top photoresist layer. Etching the non-resist layer creates a non-resist sidewall with a second sidewall angle based on the first sidewall angle. If an etch process of selectivity greater than one is used, the second sidewall angle can be made greater than the first sidewall angle. In this way, the PCM may comprise features with substantially vertical sidewalls such that mastering the bottom photoresist layer through the PCM will create features on the master with substantially vertical sidewalls.

In one embodiment, developing the bottom photoresist layer creates a bottom photoresist sidewall with a third sidewall angle based on the second sidewall angle. The third sidewall angle can be made greater than the second sidewall angle when a developer process with selectivity greater than one is used. In another embodiment, the top photoresist layer and the non-resist layer may be removed from the master prior to developing the bottom photoresist layer. The resolution of the features created on the master may then be determined by the photolithographically defined region of the bottom photoresist layer formed based on the second sidewall angle. The master may be ultimately defined by the master substrate and any number of the layers formed over the master substrate. In other words, after photolithography and etching, all of the layers may remain on the master, or alternatively one or more of the layers may be removed, with only the remaining layers defining the master features.

As another advantage, mastering a DUV resist material may provide enhanced feature resolution due to a smaller grain size in the chemical structure of the DUV resist material compared to an UV resist material. Photolithography extensions have driven conventional mask alignment systems to use DUV light sources with moderately high numerical apertures to image a small field-of-view for the integrated circuit industry. Though fine line widths have been demonstrated in state-of-the-art mask aligners, these DUV systems are unable to provide the fine feature definition necessary for modem data storage disks over the field-of-view required for the surface area of an optical disk master. Defining a master mask for the bottom photoresist layer combines the enhanced feature resolution of a DUV resist material with the fine feature definition of focused laser spot tip recording. The combination of these techniques may allow for the creation of a master having increased storage density relative to conventional masters.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an illumination system that may be used to photolithographically define regions of a data storage disk master, in accordance with embodiments of the invention.

FIG. 2 is a block diagram illustrating an etching system that may be used to physically remove regions of a data storage disk master, in accordance with embodiments of the invention.

FIGS. 3A-3E are schematic diagrams illustrating a mastering technique for a data storage disk master.

FIGS. 4A-4E are schematic diagrams illustrating another mastering technique for a data storage disk master.

FIGS. 5A-5D are schematic diagrams illustrating another mastering technique for a data storage disk master.

FIG. 6 illustrates an exemplary development process for a bottom photoresist layer of the data storage disk master from FIG. 5.

FIGS. 7A and 7B illustrate another exemplary development process for a bottom photoresist layer of the data storage disk master from FIG. 5.

FIGS. 8A and 8B illustrate another exemplary development process for bottom photoresist layer of the data storage disk master from FIG. 5.

FIG. 9 is a flow chart illustrating a method of creating a data storage disk master.

FIG. 10 is a flow chart illustrating a method of defining a contact mask for a bottom photoresist layer of the data storage disk master from FIG. 9. [00291 FIG. 11 is a schematic diagram illustrating a trench defined in a master, according to an embodiment of the invention.

### DETAILED DESCRIPTION

The invention is directed to mastering techniques that can improve the quality of a master used in data storage disk manufacturing. In particular, the techniques described herein can improve resolution of the features created on the master. The techniques include coating a master substrate layer with a trilayer structure comprising a top photoresist layer, a bottom photoresist layer, and a non-resist layer interposed between the two photoresist layers. The bottom photoresist layer comprises a deep ultraviolet (DUV) resist material. Mastering the top photoresist layer defines a contact mask, or portable conformable mask (PCM), for the bottom photoresist layer.

A number of embodiments of the invention are described in greater detail below. In one embodiment, the invention comprises a mastering technique in which a contact mask is defined for the bottom photoresist layer with an optical contrast between a photolithographically defined region of the top photoresist layer and an undeveloped region of the top photoresist layer. The top photoresist layer is illuminated by a focused laser spot to photolithographically define a feature of the master in the top photoresist layer. The top photoresist layer may comprise a mid-UV or violet material substantially opaque to a DUV light. However, the photolithographically defined region of the top photoresist layer may become substantially transparent to the DUV light. The non-resist layer may comprise a material also substantially transparent to the DUV light. Therefore, the bottom photoresist layer can be illuminated by the DUV light through the photolithographically defined region of the top photoresist layer and the non-resist layer.

In another embodiment, the invention comprises a mastering technique in which the top photoresist layer defines a contact mask for the bottom photoresist layer. The top photoresist layer can be photolithographically exposed and developed to create the contact mask. In particular, a focused laser spot illuminates the top photoresist layer to photolithographically define a feature of the master in the top photoresist layer. The top photoresist layer is then developed to remove the photolithographically defined region and physically define the feature of the master in the top photoresist layer layer. The non-resist layer may comprise a material substantially transparent to a DUV light. Therefore, the bottom photoresist layer can be illuminated by the DUV light through the contact mask and the non-resist layer.

In another embodiment, the invention comprises a mastering technique in which a combination of the top photoresist layer and the non-resist layer define a contact mask for the bottom photoresist layer. The top photoresist layer can be photolithographically exposed and developed and the non-resist layer can be etched. In that case, the top photoresist layer is illuminated by a focused laser spot to photolithographically define a feature of the master in the top photoresist layer. The top photoresist layer is then developed to remove the photolithographically defined region and physically expose a region of the non-resist layer. The physically exposed region of the non-resist layer is etched to physically define the feature of the master in the non-resist layer. Therefore, a DUV light can illuminate the bottom photoresist layer through the contact mask.

In any case, once the bottom photoresist layer is photolithographically exposed through the PCM by the DUV light, the bottom photoresist layer is developed to remove the photolithographically defined region and form the data storage disk master. In some embodiments, either the top photoresist layer or both the top photoresist layer and the non-resist layer are removed prior to developing the bottom photoresist layer. The master may be ultimately defined by the master substrate and any number of the layers formed over the master substrate. In other words, after photolithography and etching, all of the layers may remain on the master, or alternatively one or more of the layers may be removed, with only the remaining layers defining the master features.

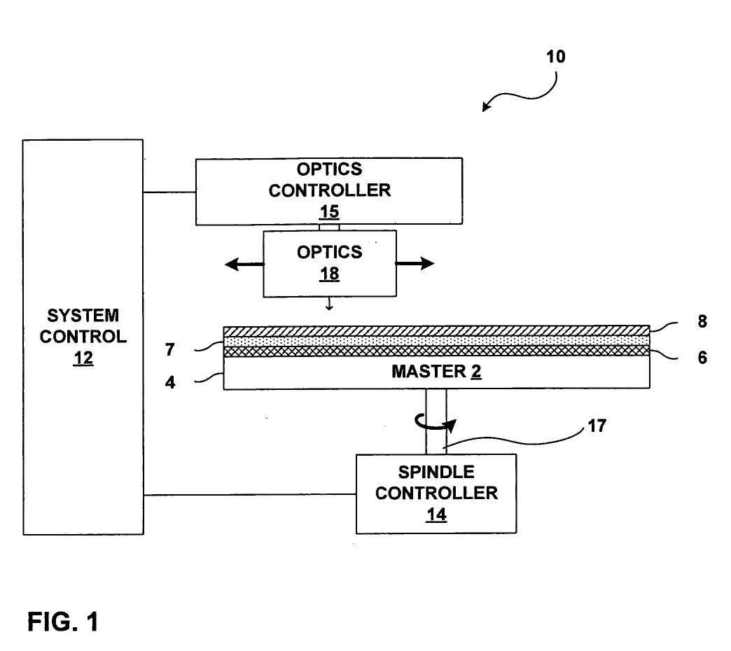

FIG. 1 is a block diagram illustrating an illumination system 10 that may be used to photolithographically define regions of master 2 in accordance with embodiments of the invention. In general, illumination system 10 includes a system control 12, such as a personal computer, workstation, or other computer system. System control 12, for example, may comprise one or more processors that execute software to provide user control over system 10. System control 12 provides commands to spindle controller 14 and optics controller 15 in response to user input. The commands sent from system control 12 to spindle controller 14 and optics controller 15 define the operation of system 10 during the photolithography process.

Data storage disk master 2 (hereafter “master 2”) may comprise a disk-shaped glass substrate 4 coated with a tri-layer structure as described herein. Other substrate materials of suitable optical surface quality may also be used for substrate 4, and non-disk shapes may also be used. The tri-layer structure includes a bottom photoresist layer 6, a non-resist layer 7, and a top photoresist layer 8. Bottom photoresist layer 6 comprises a deep ultraviolet (DUV) photoresist material. Top photoresist layer 8 may comprise a photoresist material with different optical properties than bottom photoresist layer 6. Top photoresist layer 8 may comprise a mid-UV or a violet photoresist material. Non-resist layer 7 may comprise a glass material or a metal film. As examples, the DUV material may comprise a material primarily sensitive to wavelengths of light less than 300 approximately nanometers. The mid-UV photoresist material may comprise a material primarily sensitive to wavelengths of light between approximately 400 and 300 nanometers, and the violet photoresist material may comprise a material primarily sensitive to wavelengths of light between approximately 460 nanometers and 400 nanometers.

Master 2 is carefully placed in system 10 on spindle 17. In one case, optics 18 may provide light that exposes top photoresist layer 8, according to commands by system control 12, to define at least a portion of the master mask for bottom photoresist layer 6. In another case, optics 18 may provide light that exposes bottom photoresist layer 6, according to commands by system control 12, to create the data storage disk master.

Spindle controller 14 causes spindle 17 to spin master disk 2, while optics controller 15 controls the positioning of optics 18 relative to master 2. Optics controller 15 also controls any on-off switching of light that is emitted from optics 18. As master 2 spins on spindle 17, optics controller 15 translates optics 18 to desired positions and causes optics 18 to emit light that exposes either top photoresist layer 8 or bottom photoresist layer 6.

Top photoresist layer 8 and bottom photoresist layer 6 preferably comprise two different photoresist materials applied by spin coating and non-resist layer 7 comprises a vacuum deposited thin film layer. Bottom photoresist layer 6 comprises a DUV resist material designed for DUV exposure light with a wavelength less than 300 nm. As an example, bottom photoresist layer 6 may comprise a Shipley DUVIII positive resist material commercially available from the Shipley Corporation of Marlboro, Mass. Top photoresist layer 8 may comprise a mid-UV resist material designed for UV exposure light with a wavelength between 400 nm and 300 nm or a violet resist material designed for violet exposure light with a wavelength between 460 nm and 400 nm. In either case, top photoresist layer 8 is substantially less sensitive to a DUV light than bottom photoresist layer 6. As an example, top photoresist layer 8 may comprise a Shipley 1805 positive photoresist also commercially available from the Shipley Corporation. However, in some cases, top photoresist layer 8 may include modifications of the commercial resist in order to become additionally absorptive of the DUV portion of the light spectrum.

Selecting a UV resist material for top photoresist layer 8 allows the contact mask for bottom photoresist layer 6 to be initially defined using tip recording with a focused UV laser spot. The tip recording process provides fine feature resolution in the master mask such that bottom photoresist layer 6 can be mastered using a blanket DUV light while maintaining the high resolution. The UV resist material of top photoresist layer 8 may be illuminated by the blanket DUV light without being substantially affected. The blanket DUV light may comprise an entended DUV laser beam or the DUV spectral portion of an incoherent curing lamp. In some embodiments, both top photoresist layer 8 and bottom photoresist layer 6 may comprise DUV resist material. In that case, etching non-resist layer 7 would be necessary to provide increased feature resolution relative to conventional mastering techniques.

Non-resist layer 7 may be a vacuum deposited transparent glass, e.g., SiO₂, Al2O₃-Sapphire, or an absorbing chalcogenide glass material, e.g., GeₓSe₍₁₋ₓ₎, GeSbTe, or AIST. Non-resist layer 7 may also comprise an opaque, vacuum deposited metal film. Another alternative for non-resist layer 7 includes the class of spin-on glasses, a polysilane derivative applied via spin coating and then exposed to oxygen plasma to create a thin layer of SiO₂. When creating master 2, depositing non-resist layer 7 between the two photoresist layers 6 and 8 prevents bottom photoresist layer 6 from washing away when top photoresist layer 8 is applied.

The optical properties of non-resist layer 7 depend on which process is applied to define the master mask. For example, in the embodiments where top photoresist layer 8 alone defines the PCM, non-resist layer 7 must comprise a material substantially transparent to a DUV light used to expose bottom photoresist layer 6 through non-resist layer 7. In addition, if top photoresist layer 8 is developed to define the mask, non-resist layer 7 blocks the developer solution from reaching bottom photoresist layer 8. In the embodiment where both top photoresist layer 8 and non-resist layer 7 define the PCM, non-resist layer 7 is preferably substantially opaque to a DUV light.

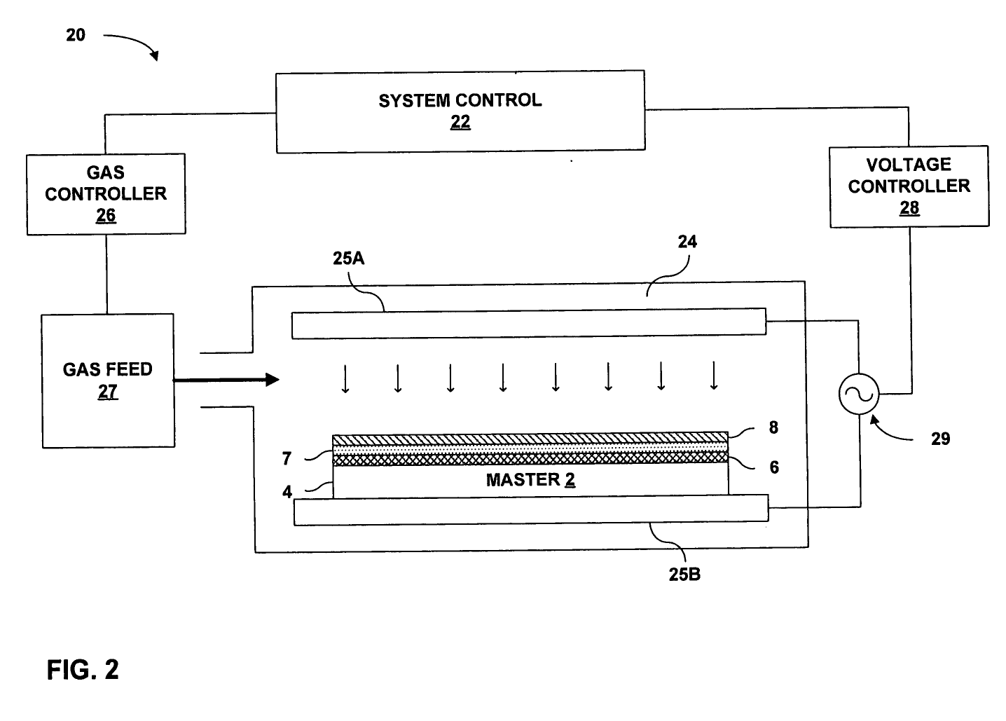

FIG. 2 is a block diagram illustrating an etching system 20 that may be used to physically remove regions of master 2 (FIG. 1), in accordance with embodiments of the invention. In some cases, etching system 20 may also be used to develop the regions of master 2 photolithographically defined by illumination system 10. In the illustrated embodiment, etching system 20 comprises a plasma etching system capable of performing reactive ion etching (RIE). In other embodiments, any of a variety of etching systems may be used, including but not limited to sputtering systems, chemical etching systems, ion beam etching systems, and wet etching systems.

In general, etching system 20 includes a system control 22, such as a personal computer, workstation, or other computer system. System control 22, for example, may comprise one or more processors that execute software to provide user control over system 20. System control 22 provides commands to gas controller 26 and voltage controller 28 in response to user input. The commands sent from system control 12 to gas controller 26 and voltage controller 28 define the operation of system 20 during the etch process.

System 20 also includes a vacuum chamber 24 with a top electrode 25A and a bottom electrode 25B driven by a power source 29. Voltage controller 28 controls power source 29 to generate a desired driving voltage level. Power source 29 provides top electrode 25A with a positive charge and bottom electrode 25B with a negative charge. A gas feed 27 introduces a gas into vacuum chamber 24 where the gas breaks down and forms a plasma. In this case, the plasma includes both etchant atoms and ions.

Master 2 is carefully placed in system 20 on bottom electrode 25B. Master 2 again includes substrate 4 coated with the tri-layer structure that includes bottom photoresist layer 6, non-resist layer 7, and top photoresist layer 8. After top photoresist layer 8 has been photolithographically exposed by optics 18 (FIG. 1) and developed by a developer process, master 2 may be placed in system 20 in order to etch physically exposed regions of non-resist layer 7. The current flowing from top electrode 25A to bottom electrode 25B causes positively-charged ions in the plasma to bombard master 2, which increases a reaction rate between the etchant atoms and non-resist layer 7. RIE also increases anisotropy of the etch process to enhance sidewall angles of the PCM, which in turn improves resolution of the features on master 2. In some embodiments, system 20, or a similar etching system, may be used to develop top and bottom photoresist layers 8 and 6 instead of using a developer solution.

The invention is generally described herein as comprising positive photoresists for both top photoresist layer 8 and bottom photoresist layer 6. In other embodiments, either positive photoresist or negative photoresist may be used. In other words, the exposure of either top photoresist layer 8 or bottom photoresist layer 6 can result in removal of the photoresist by a developer process, or the exposure can result in the creation of features with the non-exposed areas being removed by a developer process.

As described in greater detail below, master 2 includes features that can improve the mastering process. In particular, the tri-layer structure including top photoresist layer 8, non-resist layer 7, and bottom photoresist layer 6 allows a master mask to be defined for the bottom photoresist such that fine feature resolution may be obtained on master 2. DUV resist materials typically have a chemical structure comprising a grain size smaller than UV or visible resist materials. The reduced grain size allows the DUV resist material to provide enhanced feature resolution. Photolithography extensions have driven conventional mask alignment systems to use DUV light sources with moderately high numerical apertures to image a small field-of-view for the integrated circuit industry. Though fine line widths have been demonstrated in state-of-the-art mask aligners, these DUV systems are unable to provide the fine feature definition necessary for modem data storage disks over the field-of-view required for the surface area of an optical disk master. Efforts applied to UV laser sources to improve resolution, such as increasing the numerical aperture of the recording objective, become difficult for DUV light sources because optical material choices for objective lenses and/or near field optics capable of DUV irradiation are currently limited. The invention described herein combines the enhanced feature resolution of a DUV resist material with the fine feature definition of UV focused laser spot tip recording to create a master capable of providing increased storage density and improved feature definition.

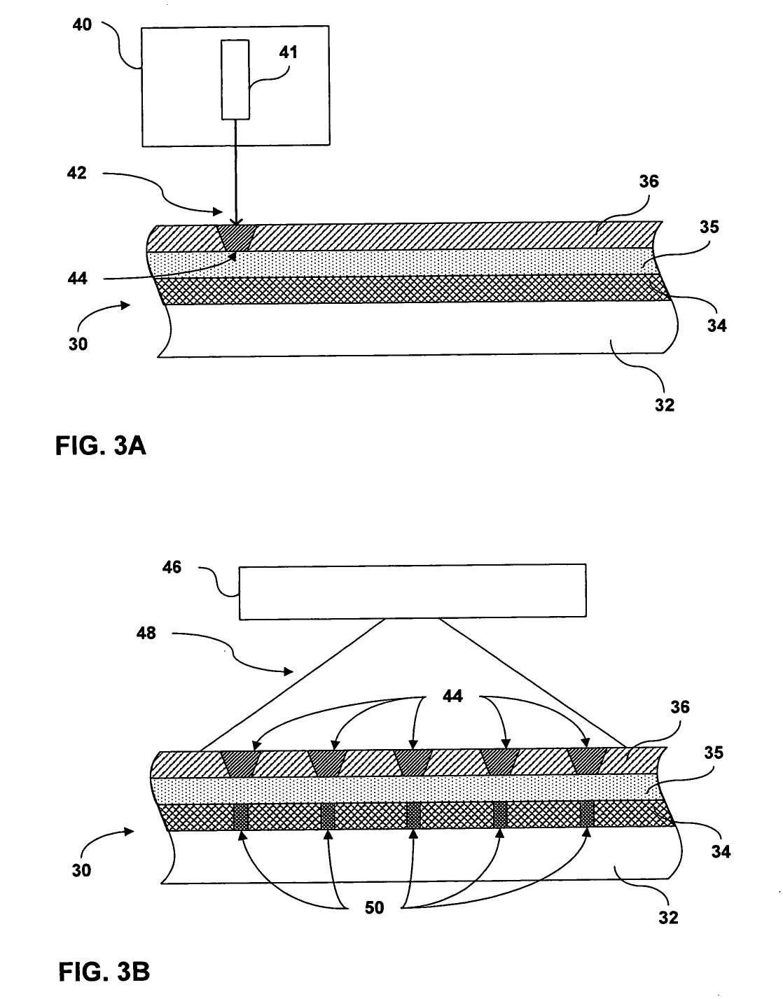

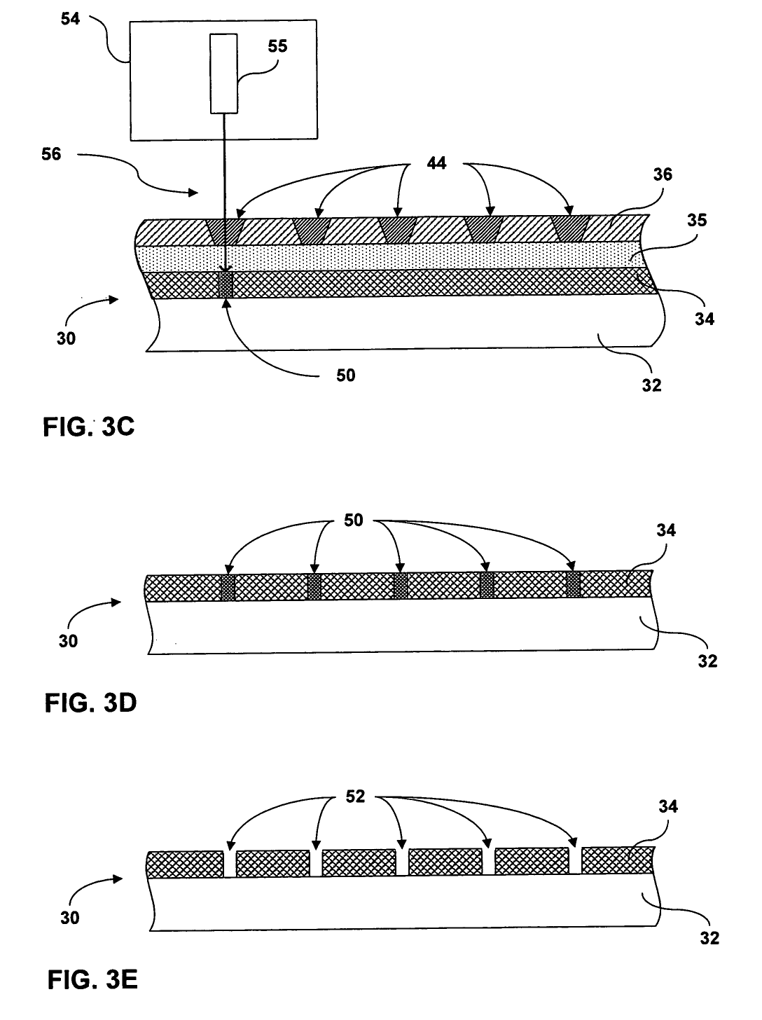

FIGS. 3A-3E are schematic diagrams illustrating a mastering technique for a master 30. Master 30 includes a substrate layer 32, a bottom photoresist layer 34, a non-resist layer 35, and a top photoresist layer 36. Bottom photoresist layer 34 comprises a deep ultraviolet (DUV) resist material designed for exposure light with a wavelength less than 300 nm. It may be assumed that top photoresist layer 36 comprises a mid-UV resist material designed for exposure light with a wavelength between 400 nm and 300 nm. In other embodiments, top photoresist layer 36 may comprise a violet resist material designed for exposure light with a wavelength between approximately 460 nm and 400 nm. In either case, top photoresist layer 36 is substantially less sensitive to a DUV light than bottom photoresist layer 34. In some cases, top photoresist layer 36 may be substantially opaque to a DUV light. In other embodiments, top photoresist layer 36 may comprise other resist materials with different optical properties.

The illustrated technique includes defining a portable conformable mask (PCM) for bottom photoresist layer 34 with an optical contrast between a photolithographically defined region 44 of top photoresist layer 36 and an undeveloped region of top photoresist layer 36.

FIG. 3A illustrates a portion of master 30 being illuminated by UV optics 40, which may operate substantially similar to optics 18 in FIG. 1. UV optics 40 includes a laser 41 that produces UV laser light. UV optics 40 then creates a precisely focused UV laser spot 42 and illuminates top photoresist layer 36 of master 30 with the focused UV laser spot 42. Illuminating top photoresist layer 36 with UV laser spot 42 photolithographically defines a region 44 of top photoresist layer 36. Photolithographically exposed region 44 may correspond to a feature of master 30, and may define a shape of a Gaussian exposure point.

UV optics 40 may then be translated in either a continuous manner for a spiral pattern or in discrete steps relative to master 30 so that during a subsequent pass, focused UV laser spot 42 exposes a different region of top photoresist layer 36. In this way, a plurality of features of master 30 may be photolithographically defined in top photoresist layer 36.

Photolithographically defining region 44 of top photoresist layer 36 defines the PCM for bottom photoresist layer 34. The tip of UV laser spot 42 provides fine feature definition for the PCM, which ensures increased resolution of the features of master 30.

FIG. 3B illustrates the portion of master 30 being illuminated by blanket DUV optics 46. DUV optics 46 produces a blanket DUV light 48. DUV light 48 illuminates bottom photoresist layer 34 of master 30 through the PCM defined with the optical contrast between photolithographically defined regions 44 and undeveloped regions of top photoresist layer 36.

Top photoresist layer 36 comprises a mid-UV resist material, which is substantially opaque to DUV light 48. In some cases, the mid-UV resist material of top photoresist layer 36 may be modified to be additionally absorptive of DUV light 48. Photolithographically defining regions 44 change the opacity of top photoresist layer 48 such that regions 44 become substantially transparent to DUV light 48. Non-resist layer 35 may comprise a glass material substantially transparent to DUV light 48. In other cases, non-resist layer 35 may comprise a metal or any etchable layer insensitive to light.

DUV light 48 propagates through regions 44 of top photoresist layer 36 and through non-resist layer 35 to reach bottom photoresist layer 34. Illuminating bottom photoresist layer 34 with DUV light 48 photolithographically defines regions 50 of bottom photoresist layer 34. Photolithographically defined regions 50 correspond to features of master 30. DUV light 48 cannot propagate though undeveloped regions of top photoresist layer 36 so the fine features defined by UV laser spot 42, i.e., regions 44, allow DUV light 48 to define high resolution features in bottom photoresist layer 34. DUV light 48 blankets a substantial portion of master 30 so that approximately all of regions 50 can be defined in bottom photoresist layer 34 at the same time.

FIG. 3C illustrates the portion of master 30 being illuminated by focused DUV optics 54 in a second mastering step. In some embodiments, focused DUV optics 54 are applied to master 30 to photolithographically expose regions of bottom photoresist layer 34 instead of blanket DUV optics 46 illustrated in FIG. 3B. DUV optics 54 includes a light source 55 that produces a focused DUV laser spot 56. DUV laser spot 56 illuminates bottom photoresist layer 34 of master 30 through the PCM defined with the optical contrast between photolithographically defined regions 44 and undeveloped regions of top photoresist layer 36.

Top photoresist layer 36 comprises a mid-UV resist material, which is substantially opaque to DUV laser spot 56. In some cases, the mid-UV resist material of top photoresist layer 36 may be modified to be additionally absorptive of DUV light 48. Photolithographically-defining regions 44 change the opacity of top photoresist layer 48 such that regions 44 become substantially transparent to DUV light 48. Non-resist layer 35 may comprise a glass material substantially transparent to DUV light 48. In other cases, non-resist layer 35 may comprise a metal or any etchable layer insensitive to light.

DUV laser spot 56 propagates through regions 44 of top photoresist layer 36 and through non-resist layer 35 to reach bottom photoresist layer 34. Illuminating bottom photoresist layer 34 with DUV laser spot 56 photolithographically defines a region 50 of bottom photoresist layer 34. Photolithographically defined region 50 corresponds to a feature of master 30. DUV laser spot 56 cannot propagate though undeveloped regions of top photoresist layer 36 so the fine features defined by UV laser spot 42, i.e., regions 44, allow DUV laser spot 56 to define high resolution features in bottom photoresist layer 34.

DUV optics 54 may be translated in either a continuous manner for a spiral pattern or in discrete steps relative to master 30 so that during a subsequent pass, DUV laser spot 56 defines a different region of bottom photoresist layer 34. In this way, a plurality of features of master 30 may be photolithographically defined in bottom photoresist layer 34.

FIG. 3D illustrates the portion of master 30 with top photoresist layer 36 and non-resist layer 35 removed. In this embodiment, bottom photoresist layer 34 can be developed before or after removing the upper two layers of the tri-layer structure. FIG. 3E illustrates the portion of master 30 with bottom photoresist layer 34 developed. A developer solution may be applied to bottom photoresist layer 34 once top photoresist layer 36 and non-resist layer 35 are removed from master 30. In other embodiments, bottom photoresist layer 34 may be developed prior to removing the top layers. The development of bottom photoresist layer 34 removes photolithographically defined regions 50 to physically define regions 52 in bottom photoresist layer 34 that define features of master 30. In that case, physically defined regions 52 may correspond to tracks of master 30.

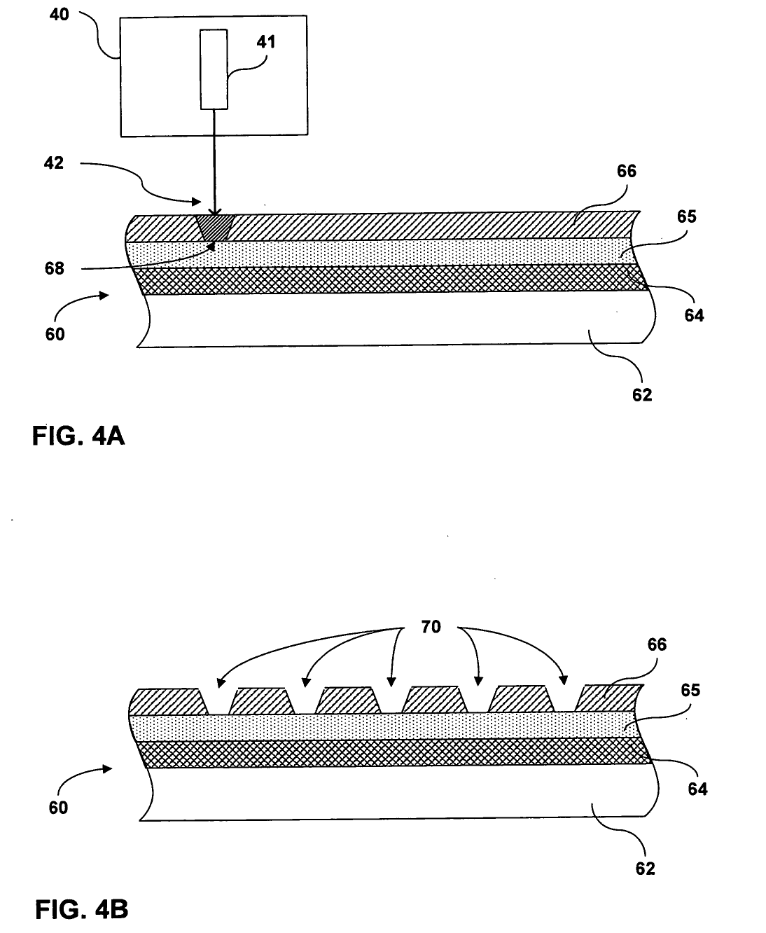

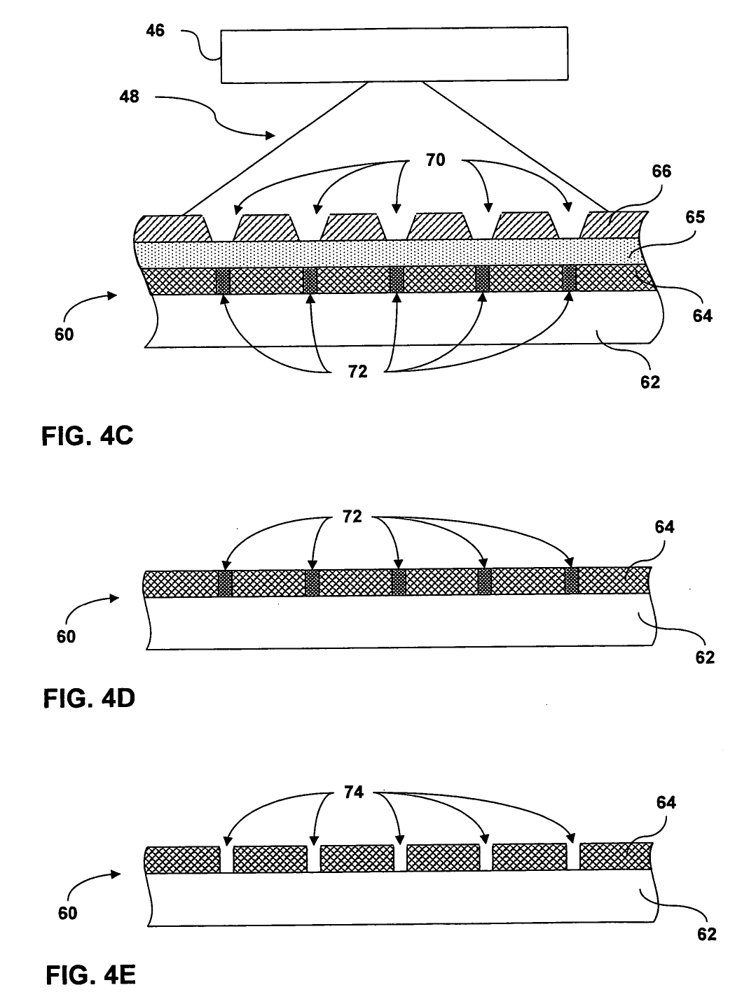

FIGS. 4A-4E are schematic diagrams illustrating a mastering technique for a master 60. Master 60 includes a substrate layer 62, a bottom photoresist layer 64, a non-resist layer 65, and a top photoresist layer 66. Bottom photoresist layer 64 comprises a deep ultraviolet (DUV) resist material designed for exposure light with a wavelength less than 300 nm. It may be assumed that top photoresist layer 66 comprises a mid-UV resist material designed for exposure light with a wavelength between 400 nm and 300 nm. In other embodiments, top photoresist layer 66 may comprise a violet resist material designed for exposure light with a wavelength between approximately 460 nm and 400 nm. In either case, top photoresist layer 66 is substantially less sensitive to a DUV light than bottom photoresist layer 64. In some cases, top photoresist layer 66 may be substantially opaque to a DUV light. In other embodiments, top photoresist layer 66 may comprise other resist materials with different optical properties.

The illustrated technique includes defining a portable conformable mask (PCM) for bottom photoresist layer 64 with top photoresist layer 66 by developing a photolithographically defined region 68 of top photoresist layer 66 to physically define a region 70 in top photoresist layer 66.

FIG. 4A illustrates a portion of master 60 being illuminated by UV optics 40 from FIG. 3A. UV optics 40 includes laser 41 that produces UV laser light used to create a precisely focused UV laser spot 42. Optics 40 illuminates top photoresist layer 66 of master 60 with focused UV laser spot 42. Illuminating top photoresist layer 66 with UV laser spot 42 photolithographically defines a region 68 of top photoresist layer 66. Photolithographically defined region 68 may correspond to a feature of master 60.

UV optics 40 may then be translated in either a continuous manner for a spiral pattern or in discrete steps relative to master 60 so that during a subsequent pass, focused UV laser spot 42 defines a different region of top photoresist layer 66. In this way, a plurality of features of master 60 may be photolithographically defined in top photoresist layer 66.

FIG. 4B illustrates the portion of master 60 with top photoresist layer 66 developed. A developer solution may be applied to top photoresist layer 66 to remove photolithographically defined regions 68 from master 60. In other embodiments, an etching system substantially similar to etching system 20 of FIG. 2 may be used to develop top photoresist layer 66. Developing top photoresist layer 66 physically defines regions 70 in top photoresist layer 66. Physically defined regions 70 may correspond to features of master 60.

Physically defining regions 70 in top photoresist layer 66 defines the PCM for bottom photoresist layer 64. The tip of UV laser spot 42 and a highly anisotropic development process provide fine feature definition for the PCM, which ensures increased resolution of the features of master 60.

FIG. 4C illustrates the portion of master 60 being illuminated by DUV optics 46 from FIG. 3B. DUV optics 46 produces a blanket DUV light 48. DUV light 48 illuminates bottom photoresist layer 64 of master 60 through the PCM defined with top photoresist layer 66 by developing a photolithographically defined region 68 of top photoresist layer 66 to physically define a region 70 in top photoresist layer 66.

Top photoresist layer 66 comprises a mid-UV resist material, which is substantially opaque to DUV light 48. In some cases, the mid-UV resist material of top photoresist layer 66 may be modified to be additionally absorptive of DUV light 48. Non-resist layer 65 may comprise a glass material substantially transparent to DUV light 48.

DUV light 48 propagates through substantially transparent non-resist layer 65 at physically defined regions 70 to reach bottom photoresist layer 64. Illuminating bottom photoresist layer 64 with DUV light 48 photolithographically defines regions 72 of bottom photoresist layer 64. Photolithographically defined regions 72 correspond to features of master 60. In other embodiments, a focused DUV laser spot (FIG. 3C) may perform a second master recording step to photolithographically define regions 72 in bottom photoresist layer 64.

DUV light 48 cannot propagate through undeveloped regions of top photoresist layer 66 so the fine features defined by UV laser spot 42, i.e., regions 70, allow DUV light 48 to define high resolution features in bottom photoresist layer 64. DUV light 48 blankets a substantial portion of master 60 so that approximately all of regions 72 can be defined in bottom photoresist layer 64 at the same time.

FIG. 4D illustrates the portion of master 60 with top photoresist layer 66 and non-resist layer 65 removed. In this embodiment, after removing the upper two layers of the tri-layer structure, bottom photoresist layer 64 can be developed. FIG. 4E illustrates the portion of master 60 with bottom photoresist layer 64 developed. A developer solution may be applied to bottom photoresist layer 64 once top photoresist layer 66 and non-resist layer 65 are removed from master 60. In other embodiments, bottom photoresist layer 64 may be developed prior to removing the top layers. Developing bottom photoresist layer 64 removes photolithographically defined regions 72 to physically define regions 74 in bottom photoresist layer 64 that define features of master 60. For example, physically defined regions 74 may correspond to tracks of master 60.

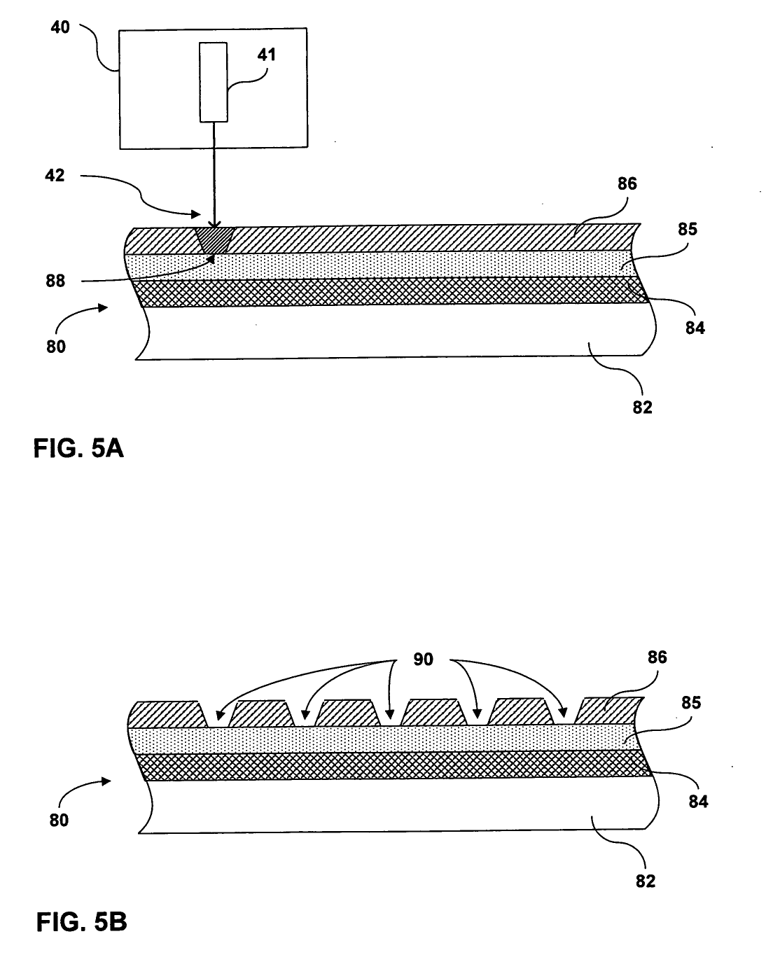

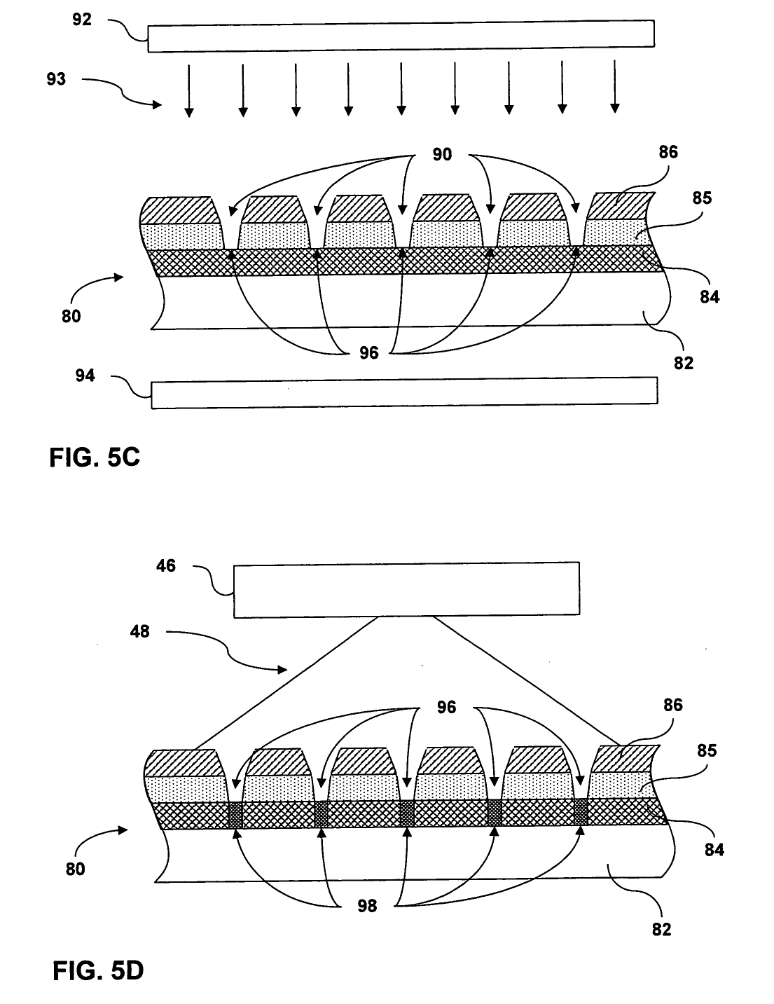

FIGS. 5A-5D and FIGS. 6-8 are schematic diagrams illustrating a mastering technique for a master 80. Master 80 includes a substrate layer 82, a bottom photoresist layer 84, a non-resist layer 85, and a top photoresist layer 86. Bottom photoresist layer 84 comprises a deep ultraviolet (DUV) resist material designed for exposure light with a wavelength less than 300 nm. Top photoresist layer 86 may comprise a mid-UV resist material designed for exposure light with a wavelength between 400 nm and 300 nm. In other embodiments, top photoresist layer 86 may comprise a violet resist material designed for exposure light with a wavelength between approximately 460 nm and 400 nm. In either case, top photoresist layer 86 is substantially less sensitive to a DUV light than bottom photoresist layer 84. In some cases, top photoresist layer 86 may be substantially opaque to a DUV light. In other embodiments, top photoresist layer 86 may comprise other resist materials with different optical properties.

The illustrated technique includes defining a portable conformable mask (PCM) for bottom photoresist layer 84 with a combination of top photoresist layer 86 and non-resist layer 85 by developing a photolithographically defined region 88 of top photoresist layer 86 to physically expose a region 90 of non-resist layer 85 and etching physically exposed region 90 of non-resist layer 85 to physically define a region 96 in non-resist layer 85.

FIG. 5A illustrates a portion of master 80 being illuminated by UV optics 40 from FIG. 3A. UV optics 40 includes laser 41 that produces UV laser light used to create a precisely focused UV laser spot 42. Optics 40 illuminates top photoresist layer 86 of master 80 with focused UV laser spot 42. Illuminating top photoresist layer 86 with UV laser spot 42 photolithographically defines a region 88 of top photoresist layer 86. Photolithographically defined region 88 may correspond to a feature of master 80.

UV optics 40 may then be translated in either a continuous manner for a spiral pattern or in discrete steps relative to master 80 so that during a subsequent pass, focused UV laser spot 42 defines a different region of top photoresist layer 86. In this way, a plurality of features of master 80 may be photolithographically defined in top photoresist layer 86.

FIG. 5B illustrates the portion of master 80 with top photoresist layer 86 developed. A developer solution may be applied to top photoresist layer 86 to remove photolithographically defined regions 88 from master 80. In other embodiments, an etching system substantially similar to etching system 20 of FIG. 2 may be used to develop top photoresist layer 86. Developing top photoresist layer 86 physically exposes regions 90 of non-resist layer 85.

FIG. 5C illustrates the portion of master 80 with non-resist layer 85 being etched. The etching process may occur in a reactive ion etching (RIE) system, which may operate substantially similar to etching system 20 from FIG. 2. In the illustrated embodiment, the etching system includes a top electrode 92 that may comprise a positive charge and a bottom electrode 94 that may comprise a negative charge. A current flowing from top electrode 92 to bottom electrode 94 causes ions 93 to bombard a surface of master 80, which increases a reaction rate of etchant atoms with non-resist layer 85. Etching non-resist layer 85 removes material at physically exposed regions 90 of non-resist layer 85 to physically define regions 96 in non-resist layer 85. Physically defined regions 96 may correspond to features of master 80.

Physically defining regions 96 in non-resist layer 85 defines the PCM for bottom photoresist layer 84. The tip of UV laser spot 42 and highly anisotropic development and etching processes provide fine feature definition for the PCM, which ensures increased resolution of the features of master 80.

FIG. 5D illustrates the portion of master 80 being illuminated by DUV optics 46 from FIG. 3B. DUV optics 46 produces a blanket DUV light 48. DUV light 48 illuminates bottom photoresist layer 84 of master 80 through the PCM defined with a combination of top photoresist layer 86 and non-resist layer 85 by developing a photolithographically defined region 88 of top photoresist layer 86 to physically expose a region 90 of non-resist layer 85 and etching at physically exposed region 90 of non-resist layer 85 to physically define a region 96 in non-resist layer 85.

Top photoresist layer 86 comprises a mid-UV resist material, which is substantially opaque to DUV light 48. In some cases, the mid-UV resist material of top photoresist layer 86 may be modified to be additionally absorptive of DUV light 48. Non-resist layer 85 may comprise one of a glass material substantially opaque to DUV light 48 or a metal film substantially opaque to DUV light 48.

DUV light 48 illuminates bottom photoresist layer 84 through physically defined regions 96 in non-resist layer 85. Illuminating bottom photoresist layer 84 with DUV light 48 photolithographically defines regions 98 in bottom photoresist layer 84. Photolithographically defined regions 98 correspond to features of master 80. In other embodiments, a focused DUV laser spot (FIG. 3C) may perform a second master recording step to photolithographically define regions 98 in bottom photoresist layer 84.

DUV light 48 cannot propagate though undeveloped regions of top photoresist layer 86 or unetched regions of non-resist layer 85. Therefore, the fine features defined by UV laser spot 42, i.e., regions 90, and the features defined by the anisotropic etching process, i.e., regions 96, allow DUV light 48 to define high resolution features in bottom photoresist layer 84. DUV light 48 blankets a substantial portion of master 80 so that approximately all of regions 98 can be defined in bottom photoresist layer 84 at the same time.

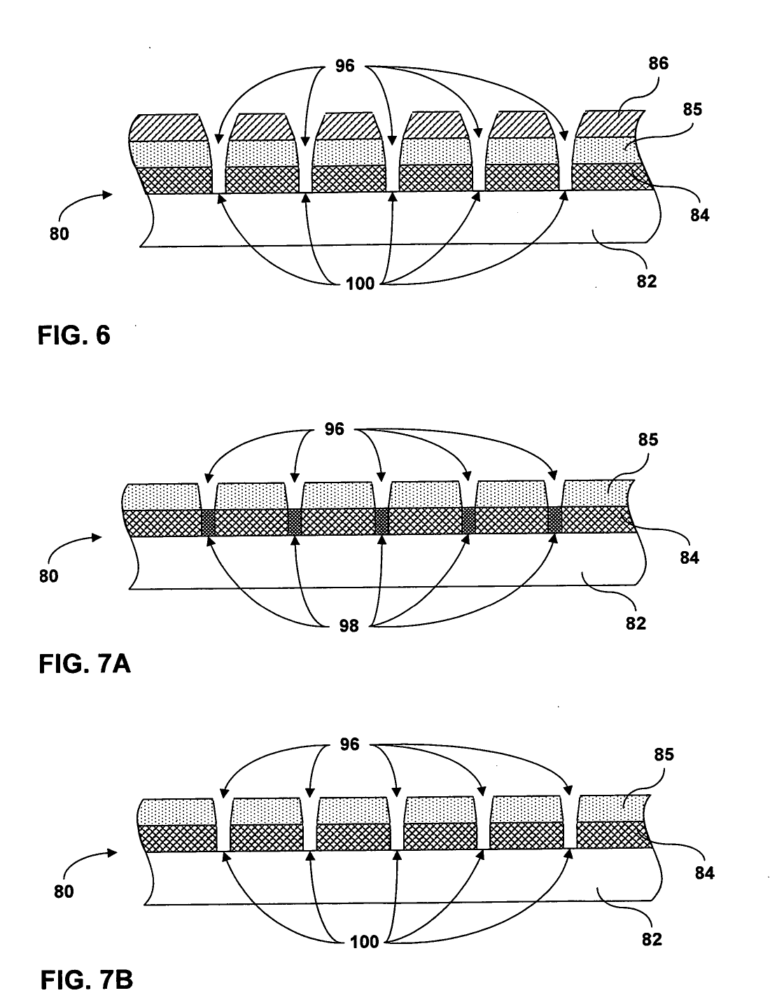

FIG. 6 illustrates an exemplary development process for bottom photoresist layer 84 of master 80. In the illustrated embodiment, top photoresist layer 86 and non-resist layer 85 remain on master 80 when bottom photoresist layer 84 is developed. A developer solution may be applied to bottom photoresist layer 84 through physically defined regions 96 of non-resist layer 85. In other embodiments, bottom photoresist layer 84 may be developed in an etching system substantially similar to etching system 20 of FIG. 2. Developing bottom photoresist layer 84 removes photolithographically defined regions 98 to physically define regions 100 in bottom photoresist layer 84 that define features of master 80. For example, physically defined regions 100 may correspond to tracks of master 80.

FIG. 7A illustrates another exemplary development process for bottom photoresist layer 84 of master 80. In this embodiment, top photoresist layer 86 is removed from master 80 prior to developing bottom photoresist layer 84. FIG. 7B illustrates the portion of master 80 with bottom photoresist layer 84 developed. A developer solution may be applied to bottom photoresist layer 84 through physically defined regions 96 of non-resist layer 85 once top photoresist layer 86 is removed from master 80. In other embodiments, bottom photoresist layer 84 may be developed prior to removal of one or more layers above the bottom photoresist layer 84. Developing bottom photoresist layer 84 removes photolithographically defined regions 98 to physically define regions 100 in bottom photoresist layer 84 that define features of master 80. For example, physically defined regions 100 may correspond to tracks of master 80.

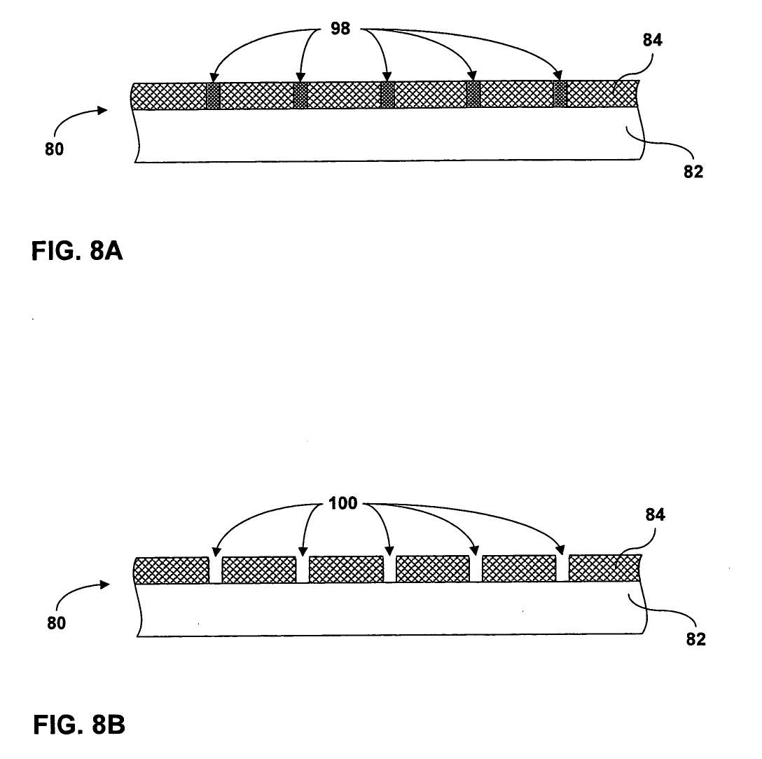

FIG. 8A illustrates another exemplary development process for bottom photoresist layer 84 of master 80. In the illustrated embodiment, top photoresist layer 86 and non-resist layer 85 are removed from master 80 prior to developing bottom photoresist layer 84. FIG. 8B illustrates the portion of master 80 with bottom photoresist layer 84 developed. A developer solution may be applied to bottom photoresist layer 84 once top photoresist layer 86 and non-resist layer 85 are removed from master 80. Developing bottom photoresist layer 84 removes photolithographically defined regions 98 to physically define regions 100 in bottom photoresist layer 84 that define features of master 80. For example, physically defined regions 100 may correspond to tracks of master 80.

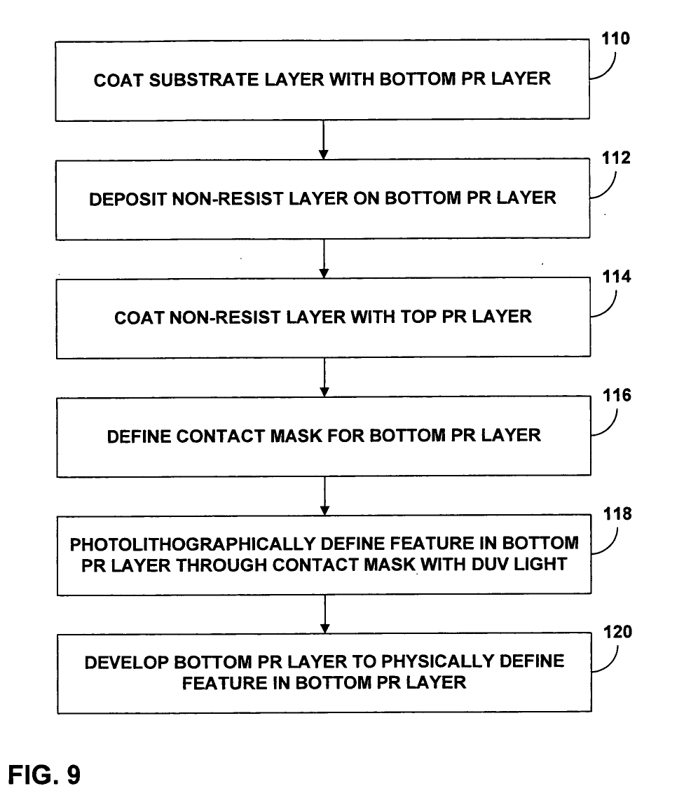

FIG. 9 is a flow chart illustrating a method of creating a data storage disk master 80 from FIGS. 5A-5D. The flow chart may also correspond to master 30 of FIGS. 3A-3E or master 60 of FIGS. 4A-4E. Master 80 includes a substrate layer 82. Substrate layer 82 is coated with a bottom photoresist layer 84, which comprises a deep ultraviolet (DUV) resist material (110). The DUV resist material is designed for DUV exposure light with a wavelength less than 300 nm. A non-resist layer 85 is deposited on bottom photoresist layer 84 (112). Non-resist layer 85 may comprise one of a glass material substantially transparent to a DUV light, a glass material substantially opaque to a DUV light, and a metal film substantially opaque to a DUV light. Non-resist layer 85 is coated with a top photoresist layer 86, which may comprise a mid-UV resist material (114). The mid-UV resist material is designed for UV exposure light with a wavelength between 400 nm and 300 nm. In other embodiments, top photoresist layer 86 may comprise a violet resist material designed for violet exposure light with a wavelength between approximately 460 nm and 400 nm. In either case, top photoresist layer 86 is substantially less sensitive to a DUV light than bottom photoresist layer 84. In some cases, top photoresist layer 86 may be substantially opaque to a DUV light.

A contact mask, or portable conformable mask (PCM), is then defined for bottom photoresist layer 84 (116). In one embodiment, the contact mask is defined with an optical contrast between a photolithographically defined region and an undeveloped region of top photoresist layer 86. In another embodiment, the contact mask is defined with top photoresist layer 86 by developing a photolithographically defined region of top photoresist layer 86 to physically define a region in top photoresist layer 86. In a further embodiment, the contact mask is defined with a combination of top photoresist layer 86 and non-resist layer 85 by developing a photolithographically defined region of top photoresist layer 86 to physically expose a region of non-resist layer 85 and etching the physically exposed region of non-resist layer 85 to physically define a region of non-resist layer 85.

Once the PCM is defined, a feature of master 80 can be photolithographically defined in bottom photoresist layer 84 through the PCM with DUV light (118). The DUV light may be a blanket DUV light such as an entended DUV laser beam or the DUV spectral portion of an incoherent curing lamp since the PCM provides fine featured definition for master 80. Alternatively, the DUV light may be a DUV focused laser spot that performs a second master recording step to photolithographically defines the feature of master 80 in bottom photoresist layer 84. Once exposed by either means, the bottom photoresist layer 84 may then be developed to physically define the feature of master 80 in bottom photoresist layer 84 (120). In some cases, top photoresist layer 86 and non-resist layer 84 are removed from master 80 prior to developing bottom photoresist layer 84.

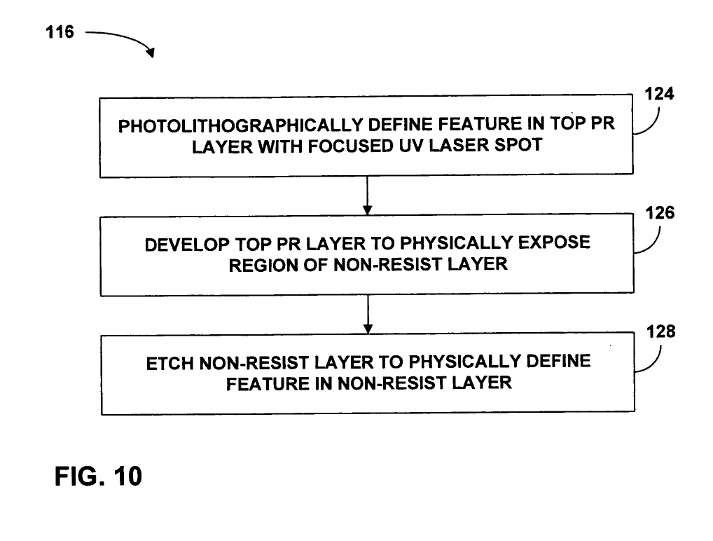

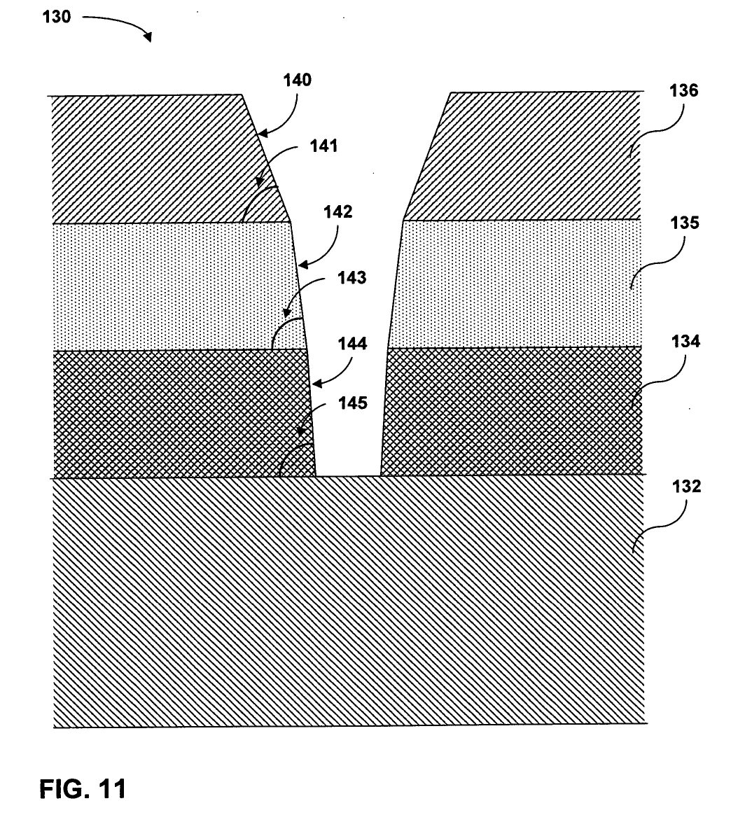

FIG. 10 is a flow chart illustrating a method of defining a contact mask for bottom photoresist layer 84 of master 80 (116) from FIG. 9. A feature of master 80 is photolithographically defined in top photoresist layer 86 using a focused UV laser spot (124). The focused UV laser spot may be used in a tip recording technique that provides fine feature resolution.

Top photoresist layer 86 is developed to physically expose a region 90 of non-resist layer 85 (126). A developer solution may be applied to top photoresist layer 86 to remove photolithographically defined region 88 from master 80. Non-resist layer 85 is then etched to physically define the feature of master 80 in non-resist layer 85 (128). Etching non-resist layer 85 removes material from master 80 at physically exposed regions 90.

As mentioned above, the process of FIG. 10 is one example of step (116) of FIG. 9. Referring again to FIG. 9, following step (116), bottom photoresist layer 84 is then illuminated by a DUV light through the contact mask defined by a combination of top photoresist layer 86 and non-resist layer 85. Illuminating bottom photoresist layer 84 photolithographically defines the feature of master 80 through physically defined regions 96 (118).

In other embodiments, the contact mask may be defined in other ways, as described above. For example, the contact mask may be defined only with the top photoresist layer by photolithographically exposing the top photoresist layer or by photolithographically exposing and then developing the top photoresist layer.

FIG. 11 is a schematic diagram illustrating a trench or groove defined in a master 130 according to an embodiment of the invention. Master 130 includes a substrate layer 132, a bottom photoresist layer 132, a non-resist layer 135, and a top photoresist layer 136. Bottom photoresist layer 132 comprises a DUV resist material designed for exposure by a DUV light with a wavelength less than 300 nm. In the illustrated embodiment, both top photoresist layer 136 and non-resist layer 135 define a contact mask, i.e., PCM, for bottom photoresist layer 134 to provide high resolution features in master 130.

Top photoresist layer 136 may comprise a UV resist material substantially opaque to the DUV light, such as a mid-UV resist material designed for exposure by a UV light with a wavelength between 400 nm and 300 nm. In other embodiments, top photoresist layer 136 may comprise a violet resist material substantially opaque to the DUV light. The violet resist material may be designed for exposure by a violet light with a wavelength between 460 nm and 400 nm. Non-resist layer 135 may comprise one of a glass material substantially opaque to the DUV light and a metal film substantially opaque to the DUV light. In other embodiments where the contact mask is defined only by top photoresist layer 136, non-resist layer may comprise a glass material substantially transparent to the DUV light.

A focused UV laser spot may photolithographically define a feature of master 130 in top photoresist layer 136. Top photoresist layer 136 may then be developed to remove the photolithographically defined region and physically define the feature of the master 130 in top photoresist layer 136. Exposing and developing top photoresist layer 136 creates a top photoresist sidewall 140 comprising a first sidewall angle 141 relative to a horizontal plane.

Master 130 may then be placed in an etching system substantially similar to etching system 20 illustrated in FIG. 2. The etching system may be capable of reactive ion etching (RIE), which is a highly anisotropic process that etches the material of non-resist layer 135 in the vertical direction at a higher rate than in the horizontal direction. Etching non-resist layer 135 creates a non-resist sidewall 142 comprising a second sidewall angle 143. Second sidewall angle 142 is based on first sidewall angle 141.

The RIE process comprises a selectivity defined by a ratio between an etch rate of non-resist layer 135 and an etch rate of top photoresist layer 136.

$${s}_{1} = \frac{{ER}_{nr}}{{ER}_{topPR}} \qquad ( 1 )$$

If s₁ comprises a selectivity greater than 1, non-resist layer 135 will be etched faster than top photoresist layer 136. In that way, top photoresist sidewall 140 will be maintained during the etching process. In addition, an increase in first sidewall angle 141, i.e., a more anisotropic developer process, will cause an increase in second sidewall angle 143. Also, for a particular first sidewall angle 141, an increase in the selectivity, s₁, causes an increase in second sidewall angle 143. As shown in FIG. 11, second sidewall angle 143 will be greater than first sidewall angle 141 for s₁ greater than 1, which increases the feature resolution on master 130.

A DUV light illuminates bottom photoresist layer 134 through the contact mask defined by top photoresist layer 136 and non-resist layer 135. Illuminating bottom photoresist layer 134 through the mask photolithographically defines the feature of master 130 in bottom photoresist layer 134. Bottom photoresist layer 134 may then be developed to remove the photolithographically defined region and physically define the feature of master 130 in bottom photoresist layer 134. Developing bottom photoresist layer 134 creates a bottom photoresist sidewall 144 comprising a third sidewall angle 145. Third sidewall angle 145 is based on second sidewall angle 143.

The developer process used for bottom photoresist layer 134 may comprise a selectivity defined by a ratio between an etch rate of bottom photoresist layer 134 and an etch rate of non-resist layer 135.

$${s}_{2} = \frac{{ER}_{bottomPR}}{{ER}_{nr}} \qquad ( 2 )$$

If S₂ comprises a selectivity greater than 1, bottom photoresist layer 134 will be etched faster than non-resist layer 135. In that way, non-resist sidewall 142 will be maintained during the developer process. In addition, an increase in second sidewall angle 143, i.e., a more anisotropic etching process, will cause an increase in third sidewall angle 145. Also, for a particular second sidewall angle 143, an increase in the selectivity, s₂, causes an increase in third sidewall angle 145. As shown in FIG. 11, third sidewall angle 145 will be greater than second sidewall angle 143 for s₂ greater than 1, which increases the feature resolution on master 130. In this way, master 130 may comprises features with substantially vertical sidewalls.

In other embodiments, top photoresist layer 136 and non-resist layer 135 may be removed from master 130 prior to developing bottom photoresist layer 134. In that case, increased feature resolution may still be provided for master 130 because the photolithographically defined region of bottom photoresist layer 134 is formed based on second sidewall angle 143. The developer process cannot take advantage of an increased selectivity, but a highly anisotropic developer process may define the fine resolution features defined by illuminating bottom photoresist layer 134 through the contact mask.

Various embodiments of the invention have been described. For example, a data storage disk mastering technique has been described that includes coating a substrate layer of a master with a tri-layer structure comprising a bottom photoresist layer and a top photoresist layer with a non-resist layer interposed between the two photoresist layers. The bottom photoresist layer comprises a DUV resist material. Either the top photoresist layer or both the top photoresist layer and the non-resist layer define a portable conformable mask (PCM) with fine feature definition for the bottom photoresist layer.

Nevertheless various modifications can be made to the techniques described herein without departing from the spirit and scope of the invention. For example, the top photoresist layer is typically described as comprising a mid-UV resist material designed for exposure by a UV light with a wavelength between 400 nm and 300 nm. However, the top photoresist layer may comprise a resist material with different optical properties than discussed herein, such as a violet resist material designed for exposure by a violet light with a wavelength between 460 nm and 400 nm. In some embodiments, top photoresist layer may comprise a DUV resist material substantially similar to the bottom photoresist layer. In that case, the non-resist layer alone may provide increased resolution of the features on the master.

Furthermore, the RIE process described herein provides a highly anisotropic etching process that provides enhanced resolution for the non-resist layer. However, a variety of etching processes may be applied to the non-resist layer. In addition, a variety of developer processes may be applied to the top and bottom photoresist layers. These and other embodiments may be within the scope of the following claims.

1. A method of creating a data storage disk master comprising:
coating a substrate layer of the master with a top photoresist layer, a bottom photoresist layer, and a non-resist layer interposed between the top and bottom photoresist layers, wherein the bottom photoresist layer comprises a deep ultraviolet (DUV) resist material;
defining a contact mask for the bottom photoresist layer by mastering the top photoresist layer; and
illuminating the bottom photoresist layer through the contact mask with a DUV light to photolithographically define a feature of the master in the bottom photoresist layer.

2. The method of claim 1, wherein mastering the top photoresist layer comprises illuminating the top photoresist layer with a focused laser spot to photolithographically define the feature of the master in the top photoresist layer.

3. The method of claim 2, further comprising defining the contact mask with an optical contrast between the photolithographically defined region and an undeveloped region of the top photoresist layer.

4. The method of claim 2, further comprising defining the contact mask with the top photoresist layer by developing the top photoresist layer to physically define the feature of the master in the top photoresist layer.

5. The method of claim 2, further comprising defining the contact mask with a combination of the top photoresist layer and the non-resist layer by developing the top photoresist layer to physically expose a region of the non-resist layer and etching the physically exposed region of the non-resist layer to physically define the feature of the master in the non-resist layer.

6. The method of claim 1, further comprising developing the bottom photoresist layer to physically define the feature of the master in the bottom photoresist layer.

7. The method of claim 6, further comprising removing at least one of the top photoresist layer and the non-resist layer from the master prior to developing the bottom photoresist layer.

8. A data storage disk master comprising:
a substrate layer;
a bottom photoresist layer coated on the substrate layer, wherein the bottom photoresist layer comprises a deep ultraviolet (DUV) resist material;
a non-resist layer deposited adjacent the bottom photoresist layer; and
a top photoresist layer coated on the non-resist layer,
wherein the top photoresist layer is mastered to define a contact mask for the bottom photoresist layer and the bottom photoresist layer is illuminated through the contact mask with a DUV light to photolithographically define a feature of the master in the bottom photoresist layer.

9. The master of claim 8, wherein the top photoresist layer comprises a mid-UV resist material substantially opaque to the DUV light.

10. The master of claim 8, wherein the non-resist layer comprises one of a glass material substantially transparent to the DUV light, a glass material substantially opaque to the DUV light, and a metal film substantially opaque to the DUV light.

11. The master of claim 8, wherein the DUV light comprises a wavelength less than 300 nanometers.

12. The master of claim 8, wherein the top photoresist layer has been illuminated by a focused laser spot to define the contact mask, and a region of the top photoresist layer photolithographically defined by the focused laser spot is substantially transparent to the DUV light.

13. The master of claim 12, wherein the focused laser spot comprises a UV laser spot with a wavelength between 400 nanometers and 300 nanometers.

14. The master of claim 8, wherein the top photoresist layer has been illuminated by a focused laser spot to photolithographically define a region of the top photoresist layer and the top photoresist layer has been developed to define the contact mask.

15. The master of claim 8, wherein the top photoresist layer has been illuminated by a focused laser spot to photolithographically define a region of the top photoresist layer, top photoresist layer has been developed to physically expose a region of the non-resist layer, and the physically exposed region of the non-resist layer has been etched to define the contact mask.

16. A method of creating a data storage disk master comprising:
coating a substrate layer of the master with a top photoresist layer, a bottom photoresist layer, and a non-resist layer interposed between the top and bottom photoresist layers, wherein the bottom photoresist layer comprises a deep ultraviolet (DUV) resist material;
illuminating the top photoresist layer with a focused laser spot to photolithographically define a feature of the master in the top photoresist layer;
developing the top photoresist layer to physically expose a region of the non-resist layer;
etching the physically exposed region of the non-resist layer to physically define the feature of the master in the non-resist layer;
illuminating the bottom photoresist layer through the physically defined region of the non-resist layer with a DUV light to photolithographically define the feature of the master in the bottom photoresist layer; and
developing the bottom photoresist layer to physically define the feature of the master in the bottom photoresist layer.

17. The method of claim 16, wherein developing the top photoresist layer includes creating a top photoresist sidewall comprising a first sidewall angle relative to a horizontal plane.

18. The method of claim 17, wherein etching the non-resist layer includes creating a non-resist sidewall comprising a second sidewall angle based on the first sidewall angle, wherein the second sidewall angle is greater than the first sidewall angle.

19. The method of claim 18, wherein developing the bottom photoresist layer includes creating a bottom photoresist sidewall comprising a third sidewall angle based on the second sidewall angle, wherein the third sidewall angle is greater than the second sidewall angle.

20. The method of claim 19, further comprising removing the top photoresist layer and the non-resist layer prior to developing the bottom photoresist layer, wherein the photolithographically defined region of the bottom photoresist layer is formed based on the second sidewall angle.
